(19) United States
(12) Patent Application Publication
(10) Pub. No.: US 2007/0023533 A1
(43) Pub. Date: Feb. 1, 2007

(54) Variable air volume terminal control systems and methods

(76) Inventor: Mingsheng Liu, Omaha, NE (US)

Correspondence Address: MICHAEL BEST & FRIEDRICH, LLP, 100 E WISCONSIN AVENUE, MILWAUKEE, WI, 53202, US

(21) Appl. No.: 11/490,535

(22) Filed: Jul. 20, 2006

Related U.S. Application Data
(60) Provisional application No. 60/701,601, filed on Jul. 22, 2005.

(51) Int. Cl. G05D 23/12; F24F 11/04

(52) U.S. Cl. 236/1 C; 165/244

(57) ABSTRACT

A method and system of controlling the temperature of a zone with airflow. In one embodiment, the method includes entering a first temperature control mode that modulates airflow to the zone between a maximum airflow set point and a minimum airflow set point to maintain the temperature of the zone between a zone cooling temperature set point and a zone heating temperature set point. The method also includes switching to a second temperature control mode upon the airflow reaching the maximum airflow set point and the temperature of the zone reaching the zone cooling temperature set point; and switching to a third temperature control mode upon the airflow reaching the minimum airflow set point and the temperature of the zone reaching the zone heating temperature set point.

### RELATED APPLICATION

This application claims priority to U.S. Provisional Patent Application Ser. No. 60/701,601, filed Jul. 22, 2005, the entire contents of which are incorporated herein by reference.

### FIELD

Embodiments of the invention relate to control systems and methods that can be applied to variable air volume and other air heating, ventilation, and/or conditioning systems.

### BACKGROUND

Heating, ventilation, and air conditioning (“HVAC”) systems supply conditioned air to one or more zones. For example, a variable air volume (“VAV”) system generally includes various components (e.g., a heating device, one or more dampers, etc.) that control the manner in which airflow is conditioned prior to reaching the one or more zones.

### SUMMARY

In one embodiment, a method of controlling the temperature of a zone with airflow includes initializing a controller. The controller stores a set of parameters that comprises a minimum airflow set point, a maximum airflow set point, a zone cooling temperature set point, and a zone heating temperature set point. The method also includes entering a first temperature control mode upon initialization of the controller. The first temperature control mode modulates airflow to the zone between the maximum airflow set point and the minimum airflow set point to maintain the temperature of the zone between the zone cooling temperature set point and the zone heating temperature set point. The method also includes switching to a second temperature control mode upon the airflow reaching the maximum airflow set point and the temperature of the zone reaching the zone cooling temperature set point. The method further includes switching to a third temperature control mode upon the airflow reaching the minimum airflow set point and the temperature of the zone reaching the zone heating temperature set point.

In another embodiment, a temperature control system for a zone includes an airflow source, an airflow measurement device, a damper, a heating device, a thermostat, and a controller. The airflow source provides airflow to the zone. The airflow measurement device measures airflow to the zone. The damper controls airflow to the zone. The heating device heats the airflow. The thermostat device measures the temperature of the zone. The controller is in communication with the airflow measurement device, the damper, the heating device, and the thermostat, and alters the airflow to the zone using at least one of the damper and the heating device based at least partially on the temperature of the zone and the airflow to the zone.

In another embodiment, an existing temperature control system includes a controller and a first set of commands for controlling airflow to a zone. A method of reconfiguring the existing temperature control system includes accessing the controller; deactivating at least a portion of the first set of commands; and programming the controller with a second set of temperature control system commands. The second set of temperature control system commands alter the airflow to the zone based on the temperature of the zone and the airflow being routed to the zone.

Other aspects of the invention will become apparent by consideration of the detailed description and accompanying drawings.

### BRIEF DESCRIPTION OF THE DRAWINGS

FIG. 1 illustrates a temperature control system according to an embodiment of the invention.

FIG. 2 illustrates another temperature control system according to an embodiment of the invention.

FIG. 3 illustrates a process for controlling the temperature of a zone according to an embodiment of the invention.

FIG. 4 illustrates another process for controlling the temperature of a zone according to an embodiment of the invention.

FIG. 5 illustrates a process for reconfiguring an existing temperature control system according to an embodiment of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

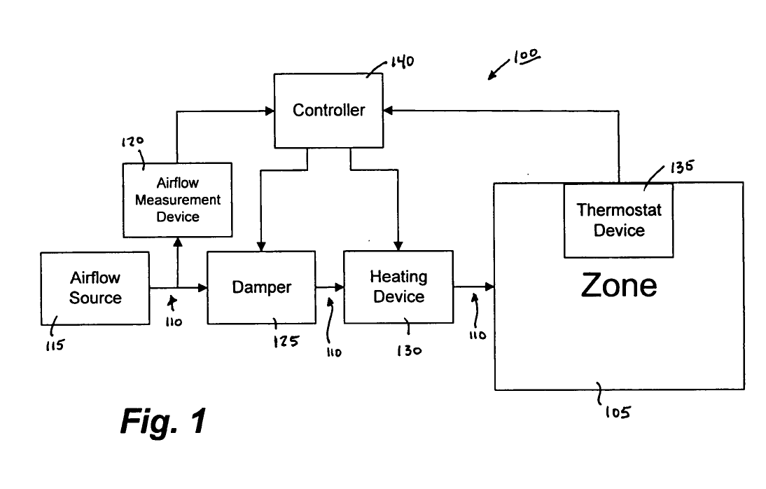

FIG. 1 illustrates a temperature control system 100 according to an embodiment of the invention. In some embodiments, the temperature control system 100 can be utilized to control the temperature of a zone 105 by manipulating airflow 110 from an airflow source 115, as described in greater detail below. The airflow source 115 can be, for example, an air handling unit that provides a stream of conditioned air. Generally, the temperature control system 100 includes an airflow measurement device 120, a damper 125, a heating device 130, and a thermostat device 135. The temperature control system 100 also includes a controller 140, which interacts with various components of the temperature control system 100, as described below.

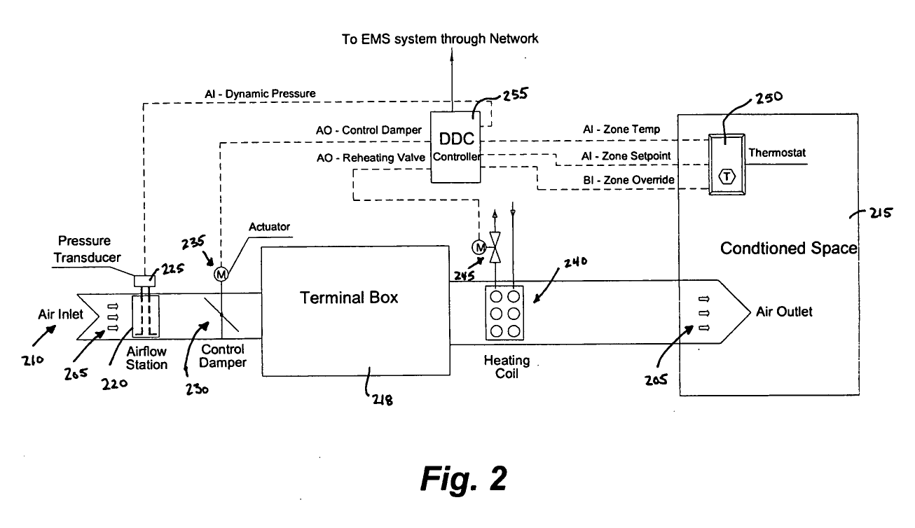

The airflow measurement device 120 measures parameters of the airflow 110. For example, as described with respect to FIG. 2, the airflow measurement device 120 can include a pressure transducer which measures the pressure of the airflow 110 prior to the damper 125. The airflow measurement device 120 can also measure the speed at which the airflow 110 moves. Additionally or alternatively, the airflow measurement device 120 may measure the relative humidity and/or temperature of the airflow 110.

In the embodiment shown in FIG. 1, the damper 125 controls how much of the airflow 110 is allowed to flow to the zone 105. For example, the damper 125 can be moved from a fully open position, which allows nearly all of the airflow 110 to flow to the zone 105, to a fully closed position, which allows very little, if any, of the airflow 110 to flow to the zone 105. In some embodiments, the damper 125 is electronically controlled (e.g., moved between the fully open position to the fully closed position) via an actuator, as described with respect to FIG. 2. In other embodiments, the damper 125 can be controlled in an alternative manner (e.g., hydraulically opened and closed).

The heating device 130 is positioned downstream of the damper 125, and has the ability to heat the airflow 110 as the airflow 110 flows to the zone 105. However, the heating device 130 also has the ability to be turned off, such that the airflow 110 is not heated while en route to the zone 105. The heating device 130 can be a suitable mechanism, such as, for example, coils or other elements heated by hot water, a furnace mechanism (e.g., a gas-fueled furnace), an electrically charged heating element, and the like. Additionally, the temperature of the heating device 130 can be modulated. As such, the airflow 110 that flows over, around, or through the heating device 130 may be heated to different temperatures, depending on the state and temperature of the heating device 130.

The thermostat device 135 generates and/or otherwise provides one or more temperature-related signals to the controller 140. For example, in one embodiment, the thermostat device 135 is a thermometer that provides a temperature signal to the controller 140. Alternatively or additionally, the thermostat device 135 can provide temperature set point signals (e.g., a heating set point and a cooling set point), temperature override signals, and/or a variety of other temperature-related signals.

Generally, the controller 140 can be a suitable electronic device, such as, for example, a programmable logic controller (“PLC”), a personal computer (“PC”), and/or other industrial/personal computing device. As such, the controller 140 may include both hardware and software components, and is meant to broadly encompass the combination of such components. In the embodiment shown in FIG. 1, the controller 140 receives signals from the airflow measurement device 120 and the thermostat device 135, and transmits signals to the damper 125 and the heating device 130. In some embodiments, the signals received by the controller 140 are used to generate signals that are transmitted to the damper 125 and the heating device 130. For example, as described in greater detail below, the controller 140 may receive a temperature signal from the thermostat device 135, and use that temperature signal to generate a signal that is transmitted to turn the heating device 130 on or off.

In other embodiments, the temperature control system 100 shown in FIG. 1 can include more or fewer elements than those shown. For example, in alternative embodiments, the temperature control system 100 may include airflow filters, additional or alternative airflow sensors, and/or may route airflow to additional zones. Additionally or alternatively, in other embodiments, the temperature control system 100 may be configured differently than that shown in FIG. 1. For example, in alternative embodiments, the heating device 130 may be positioned prior to the damper 125; the airflow measurement device 120 may be positioned further downstream of the airflow source 115; etc.

FIG. 2 illustrates another temperature control system 200 according to an embodiment of the invention. The temperature control system 200 allows airflow 205 to flow from an air inlet 210 to a conditioned space or zone 215 through a terminal box 218. The temperature control system 200 generally includes an airflow station 220 having a pressure transducer 225, a control damper 230 having an actuator 235, and one or more heating coils 240 having a valve 245. The temperature control system 200 also includes a thermostat 250 and a controller 255.

In the embodiment shown in FIG. 2, the airflow station 220 and pressure transducer 225 are positioned prior to, or upstream of, the control damper 230. As such, the airflow pressure measured by the airflow station 220 and pressure transducer 225 is altered by changing the position of the control damper 230. This pressure data is transmitted from the airflow station 220 and pressure transducer 225 to the controller 255, which can use the data to control and/or manipulate components of the temperature control system 200 (e.g., the position of the control damper 230). Additionally, as described above, the airflow station 220 can also transmit other data (e.g., relative humidity of the airflow 205, temperature of the airflow 205, etc.) to the controller 255.

The control damper 230 and actuator 235 are positioned upstream of the heating coil 240. In some embodiments, the actuator 235 receives control signals from the controller 255 and opens or closes the control damper 230 in accordance with those signals. For example, in one embodiment, the actuator 235 is an electric motor that receives motor control signals. The electric motor then turns in one direction to open the control damper 230, and in the opposite direction to close the control damper 230. In this way, the control damper 230 can be moved from a fully open position, which allows all of the airflow 205 to pass through the control damper 230, to a fully closed position, which allows none of the airflow 205 to pass through the control damper 230. In other embodiments, an alternative mechanism may be used to control the position of the control damper 230 (e.g., a hydraulic control mechanism). Additionally or alternatively, in other embodiments, the temperature control system 200 may include more than one control damper 230 and actuator 235.

The heating coil 240 and valve 245 are positioned prior to the zone 215. In some embodiments, the valve 245 receives control signals from the controller 255 and opens or closes in accordance with those signals. For example, in one embodiment, the valve 245 is a hot water valve that receives control signals to open or close the valve 245. In this way, the valve 245 controls the amount of hot water that flows through the heating coil 240, thereby controlling the temperature of the heating coil 240. By controlling the operation of the valve 245 and the related temperature of the heating coil 240, the controller 255 can control the temperature of the airflow 205 that is routed to the zone 215. In other embodiments, the valve 245 and heating coil 240 can be replaced with alternative components. For example, as previously described, the heating coil 240 may be replaced by a gas heating unit. Other alternatives are also possible.

In some embodiments, the airflow station 220 and pressure transducer 225, the control damper 230 and actuator 235, the heating coil 240 and valve 245, the controller 255, or any combination thereof can be grouped in the terminal box 218. By grouping the above-listed components in the terminal box 218, installation, troubleshooting, and general maintenance activities for the components may be more easily performed (e.g., because all of the components are positioned in a centralized location). In other embodiments, the components of the temperature control system 200 may not be centrally located.

Generally, the thermostat 250 generates and/or otherwise provides temperature data to the controller 255. For example, in one embodiment, the thermostat 250 provides a temperature signal to the controller 255, indicating the temperature of the zone 215. The controller 255 can then use that temperature data to manipulate other components of the temperature control system 200 (e.g., the control damper 230, the heating coil 240, etc.). In other embodiments, the thermostat 250 can be a more complex device. For example, the thermostat 250 can also provide zone temperature set points—in other words, the temperatures at which the zone 215 is required to be cooled or heated. For example, the zone temperature heating set point may be set to 70 degrees Fahrenheit, while the zone temperature cooling set point may be set to 73 degrees Fahrenheit. Typically, the zone temperature heating set point and the zone temperature cooling set point are approximately 2-3 degrees Fahrenheit apart; however, a broader or narrower temperature band can be used. A zone override temperature can also be set by the thermostat 250. The zone override temperature is a desired zone temperature manually set by a user. In instances where the zone temperature set points and the zone override temperature are controlled with the thermostat 250, the thermostat 250 may also include a security device (e.g., a key, an access code, etc.), so that the zone temperature set points are not changed by accident or by unauthorized personnel. In alternative embodiments, as discussed in greater detail below, the zone temperature set points and the zone override temperature may be in the controller 255, remote from the zone 215.

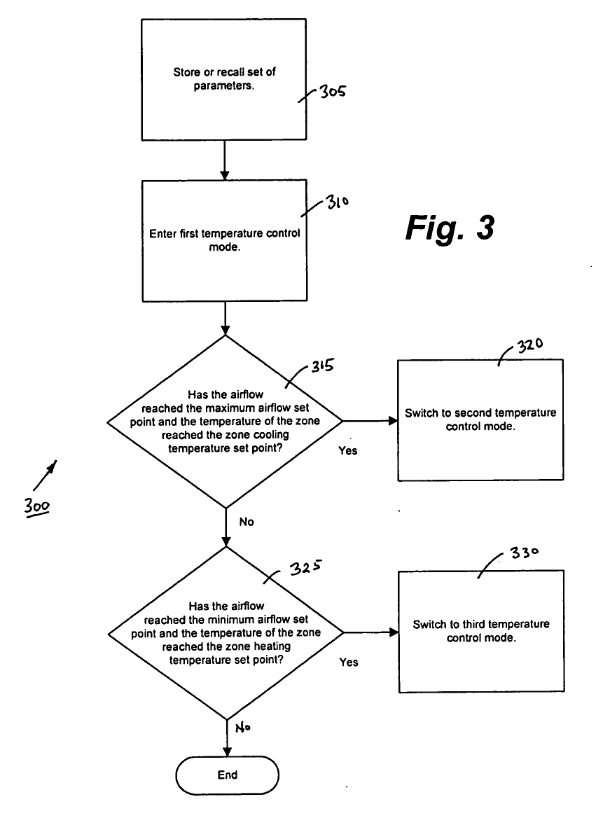

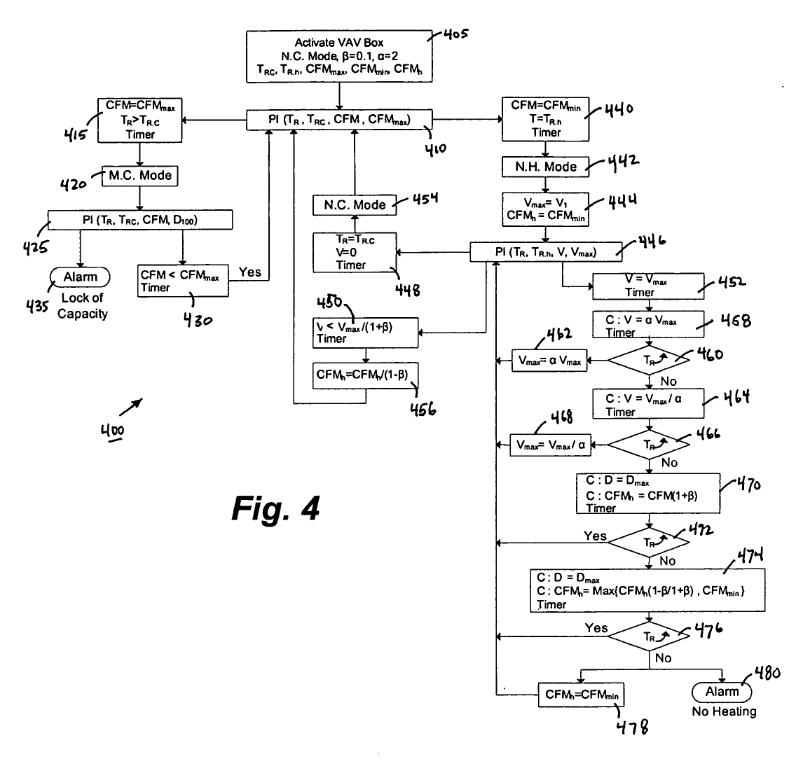

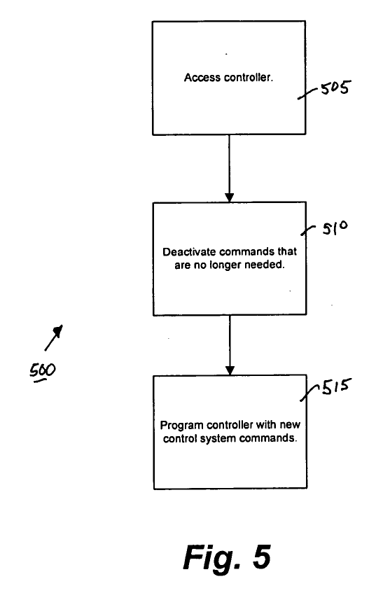

The controller 255 receives data signals from several of the components of the temperature control system 200, and transmits control signals to other components. In some embodiments, prior to receiving the data signals from the various components of the temperature control system 200, the controller 255 polls, or requests the data signals from the components. To effectively transmit and receive (e.g., communicate) the signals, the controller 255 is linked to each of the components of the temperature control system 200, as shown in FIG. 2. The links can be wired or wireless connections, and the signals can be transmitted and received at different rates. In order to perform functions (e.g., transmitting a control signal to the actuator 235), the controller 255 includes a set of commands and/or parameters, or a program. The set of commands can be stored, accessed, and/or changed (e.g., see FIG. 5), and can be created using a variety of computer programming languages (e.g., ladder logic, C++ commands, etc.). Additionally or alternatively, the controller can include one or more predetermined functionalities (e.g., proportional-integral (“PI”) control, proportional-integral-derivative (“P ID”) control, etc.). In one embodiment, parameters stored in the controller 255 include a maximum airflow set point, a minimum airflow set point, a damper position value, and a valve position value. The maximum airflow set point corresponds to the maximum amount of airflow 205 that the temperature control system 200 is designed to handle. Conversely, the minimum airflow set point corresponds to the minimum amount of airflow 205 that the temperature control system 200 is designed to handle. The maximum and minimum airflow set points are generally static values that are input by a temperature control system designer. However, the other parameters, such as the damper position value and the valve position value, can be variable, and can be updated or changed as their status changes (e.g., the position of the valve 245 changes). The program can also include the previously-described zone temperature set points, or other parameters needed to carry out the various functions. As described below (e.g., FIGS. 3-4), the program stored in the controller 255 can also contain one or more temperature control modes, each mode having associated functions to maintain or vary the temperature of the zone 215.

FIG. 3 illustrates a process 300 for controlling the temperature of a zone according to an embodiment of the invention. The process 300 can be carried out, for example, by the controller 140 or the controller 255 shown in FIGS. 1 and 2, respectively. However, it should be noted that although the process 300 is described as being carried out by the temperature control system 200 (FIG. 2), the process 300 can be implemented in a variety of different temperature control systems.

The first step in the process 300 is to initialize the controller 255 (step 305). Initializing the controller 255 can include, for example, supplying power to the controller 255 or executing a command. In some instances, the controller 255 may already be initialized (e.g., the controller 255 is already executing commands), in which case, step 305 can be omitted. The next step in the process 300 is to enter a first temperature control mode (step 310). Temperature control modes, as described in greater detail with respect to FIG. 4, each have certain associated subsets of commands or processes. For example, the first temperature control mode can include a subset of processes that are used to cool the zone 205. Additionally, a second temperature control mode can include a different subset of processes that are used to cool the zone 205. Conversely, a third temperature control mode can include a subset of processes that are used to heat the zone 205. Other temperature control modes are also possible.

The next step in the process 300 is to check whether the airflow 205 has reached a maximum airflow set point, and whether the temperature of the zone 215 has reached a zone cooling temperature set point (step 315). This can be completed, for example, by polling or otherwise accessing the signals from the airflow station 220 and pressure transducer 225, and thermostat 250, respectively. If both of the conditions set forth in step 315 are satisfied, or are “true” (e.g., the airflow 205 has reached the maximum airflow set point and the temperature of the zone 215 has reached, or exceeds, the zone cooling temperature set point), the controller 255 switches to a second temperature control mode (step 320). If the conditions set forth in step 315 are not true, the process continues by checking whether the airflow 205 has reached a minimum airflow set point, and whether the temperature of the zone has reached a zone heating temperature set point (step 325). If the conditions set forth in step 325 are true, the process 300 switches to a third temperature control mode (step 330). If, however, the conditions set forth in step 325 have not been satisfied, the process 300 ends, and the controller 255 remains in the first temperature control mode. In some embodiments, the process 300 can be continually repeated, allowing the temperature control mode to be changed according to changing zone conditions. Additionally, in other embodiments, steps within the process 300 can be carried out in a different order (e.g., step 325 is carried out prior to step 315).

FIG. 4 illustrates another process 400 for controlling the temperature of a zone according to an embodiment of the invention. Similar to FIG. 3, the process 400 is described as being carried out by one or more components of the temperature control system 200. However, in other embodiments, the process 400 can be applied to a variety of temperature control systems, and is not limited to the temperature control system components shown in FIG. 2. The first step of the process 400 is to activate the terminal box 218 and associated controller 255 (step 405). In some embodiments, activating the terminal box 218 includes entering a normal cooling mode (“N.C. mode”) and setting a beta parameter (β), an alpha parameter or valve scale factor (α), a zone cooling temperature set point (T_{RC}), a zone heating temperature set point (T_{RH}), a minimum cooling airflow value (CFM_{MIN}), a maximum cooling airflow value (CFM_{MAX}), and a heating airflow set point (CFMₕ). In some embodiments, a user inputs the zone heating temperature set point (T_{RH}) and the zone cooling temperature set point (T_{RC}). For example, a user in the zone 215 can complete this task using the thermostat 250. As previously described, the zone heating temperature set point (T_{RH}) and the zone cooling temperature set point (T_{RC}) are typically 2-3 degrees Fahrenheit apart. In contrast, the minimum cooling airflow value (CFM_{MIN}), the maximum cooling airflow value (CFM_{MAX}), and the heating airflow set point (CFMₕ) are typically set by a system installer based on the type and size of the temperature control system. The variable beta parameter (β) and alpha parameter (α) are set to 0.1 and 2, respectively, and are also generally set by a system installer. Changing the beta parameter (β) and the alpha parameter (α) may change the speed at which the temperature control system 200 reacts to changing zone temperature conditions (e.g., gain values).

While in the N.C. mode, the zone cooling temperature set point (T_{RC}) is maintained by modulating airflow between the minimum cooling airflow value (CFM_{MIN}) and the maximum cooling airflow value (CFM_{MAX}) through a PI control loop (step 410). While carrying out step 410, the controller 255 also checks two sets of conditions. For example, the controller 255 checks a first set of conditions to determine if the current airflow (CFM) reaches the maximum cooling airflow value (CFM_{MAX}) and if the zone temperature (T_{R}) is higher than the zone cooling temperature set point (T_{RC}) (step 415). If the conditions set forth in the first set of conditions (step 415) are true, the controller 255 enters a maximum cooling mode (“M.C. mode”) (step 420). While in the M.C. mode, the controller 255 modulates the control damper position (D) to maintain the zone cooling temperature set point (T_{RC}), regardless of the actual airflow (CRM) (e.g., the airflow is not restricted to the maximum cooling airflow value (CFM_{MAX})) (step 425). The control damper position (D) is calculated using a PI control loop, and is carried out by the actuator 235 (step 425). While in the M.C. mode, the controller 255 also continues to monitor the actual airflow (CFM) (step 430). If the actual airflow (CFM) is below the maximum cooling airflow value (CFM_{MAX}) for a predetermined period of time (e.g., five to ten minutes), the controller 255 switches from the M.C. mode to the N.C. mode. The controller 255 can also initialize an alarm to indicate that the capacity of the temperature control system 200 is not great enough to cool the zone 215 to the required temperature (step 435).

Referring again to the N.C. mode described in step 410, the controller 255 also checks a second set of conditions. For example, the controller 255 checks the second set of conditions to determine if the actual airflow (CFM) reaches the minimum cooling airflow value (CFM_{MIN}) and if the zone temperature (T_{R}) reaches the zone heating temperature set point (T_{RH}) (step 440). If the conditions set forth in step 440 are true, the controller 255 switches to a normal heating mode (“N.H. mode”) (step 442). While in the N.H. mode, the heating airflow set point (CFMₕ) is set equal to the maximum cooling airflow value (CFM_{MAX}), and the maximum valve position or the limit of the valve 245 (V_{MAX}) is initialized or set to variable V₁ (step 444). In some embodiments, the maximum valve position (V_{MAX}) is initially set to 10% of the full open position, which helps to prevent the heating coil 240 from getting too hot and/or other mechanical- or heating-related malfunctions, such as those caused by closing the valve 245 too tightly. The controller 255 then modulates the valve position V between 0 and the maximum valve position (V_{MAX}) to maintain the zone heating temperature set point (T_{RH}) (step 446). This can be accomplished, for example, using a PI control loop.

Additionally, while in the N.H. mode, the controller 255 checks the following three conditions: (1) if the valve position (V) is fully closed (e.g., 0) and the zone temperature (T_{R}) reaches the zone cooling temperature set point (T_{RC}) (step 448); (2) if the valve position (V) is less than a ratio of the maximum valve position (V_{MAX}) and the valve scale factor (α) (step 450); and (3) the valve position (V) reaches the maximum position (V_{MAX}) and the zone temperature (T_{R}) is below the zone heating temperature set point (T_{RH}) (step 452). Each of the three conditions are described in greater detail below.

When the first condition is satisfied (e.g., the conditions set forth in step 448), the controller 255 switches to the N.C. mode (step 454) and the PI control loop set forth in step 410 is enabled. When the second condition is satisfied (e.g., the conditions set forth in step 450), the heating airflow set point (CFMₕ) is scaled back by a factor of (1−β) (step 456) and the PI control loop set forth in step 410 is enabled. This reduces the amount of heated airflow that is routed to the zone 215. When the third condition is satisfied (e.g., the conditions set forth in step 452), the valve position (V) is set to the current maximum valve position (V_{MAX}) multiplied by the valve scale factor (α) (step 458). The controller 255 then monitors the zone temperature (T_{R}) (step 460). If the zone temperature (T_{R}) increases, the controller 255 sets the maximum valve position (V_{MAX}) to the valve scale factor (α) multiplied by the current maximum valve position (V_{MAX}) (step 462), and returns to the PI control loop set forth in step 446. If the zone temperature (T_{R}) does not increase, the controller 255 continues to modulate the valve position (V) to maintain the zone temperature (T_{R}). For example, the controller 255 reduces the maximum position (V_{MAX}) by the valve scale factor (α) (step 464). The controller 255 then monitors the zone temperature (T_{R}) (step 466). If the zone temperature (T_{R}) increases, the controller 255 sets the maximum valve position (V_{MAX}) to V_{MAX}/α (step 468), and returns to the PI control loop set forth in step 446.

If the zone temperature (T_{R}) does not increase following step 466, the controller 255 sets the damper position (D) to the maximum damper position (D_{MAX}) (e.g., the damper is fully open), and increases the heating airflow set point (CFMₕ) by a factor of (1+β) (step 470). The controller 255 then monitors the zone temperature (T_{R}) (step 472). If the zone temperature (T_{R}) increases, the controller 255 returns to the PI control loop set forth in step 446. If, however, the zone temperature (T_{R}) does not increase, the controller 255 decreases the heating airflow set point (CFMₕ) if the heating airflow set point (CFMₕ) is not already at the minimum value (CFM_{MIN}) (step 474). The controller 255 then monitors the zone temperature (T_{R}) (step 476). If the zone temperature (T_{R}) increases, the controller 255 returns to the heating PI control loop set forth in step 446. If, however, the zone temperature (T_{R}) does not increase, the controller 255 sets heating airflow set point (CFMₕ) to the minimum value (CFM_{MIN}) (step 478), and returns to the PI control loop set forth in step 446. By setting the heating airflow set point (CFMₕ) to the minimum value, the N.H. mode has been reset. This reset can indicate that the heating coil 240 or valve 245 has failed or is otherwise malfunctioning (i.e., the airflow 205 is no longer being heated). As such, an alarm is also issued (step 480). The alarm can be an audible or visual alarm (e.g., a flashing light). Additionally or alternatively, the alarm can be contained within the program of the controller 255.

FIG. 5 illustrates a process 500 for reconfiguring a temperature control system that controls airflow to at least one zone (e.g., the temperature control systems shown in FIGS. 1 and 2) according to an embodiment of the invention. The process 500 can be used, for example, to reconfigure a controller of an existing temperature control system with the process 300 and/or the process 400 shown in FIGS. 3 and 4, respectively. The process 500 begins by accessing the controller of the temperature control system that is going to be reconfigured (step 505). Accessing the controller may include, for example, accessing the commands or program of the controller. The next step in the process 500 is to deactivate the commands that are no longer needed by the controller (i.e., the commands that will no longer be needed after the new process or processes are in place) (step 510). Deactivating the commands of the existing controller can include, for example, deleting or otherwise disabling the commands. The final step in the process 500 is to program the controller with new commands (step 515). This step can include uploading a new process, such as process 300 and/or process 400, into the controller. In this way, the temperature control system can be updated to alter the airflow to the zone based on the temperature of the zone and the airflow being routed to the zone.

Various embodiments are set forth in the following claims.

What is claimed is:

1. A method of controlling the temperature of a zone with airflow, the method comprising:
storing, for use by a controller, a set of parameters that comprises a minimum airflow set point, a maximum airflow set point, a zone cooling temperature set point, and a zone heating temperature set point;
entering a first temperature control mode upon initialization of the controller, wherein the first temperature control mode modulates airflow to the zone between the maximum airflow set point and the minimum airflow set point to maintain the temperature of the zone between the zone cooling temperature set point and the zone heating temperature set point;
switching to a second temperature control mode upon the airflow reaching the maximum airflow set point and the temperature of the zone reaching the zone cooling temperature set point; and
switching to a third temperature control mode upon the airflow reaching the minimum airflow set point and the temperature of the zone reaching the zone heating temperature set point.

2. The method of claim 1, wherein a difference of approximately 2 degrees Fahrenheit is between the zone cooling temperature set point and the zone heating temperature set point.

3. The method of claim 1, further comprising maintaining, while in the second temperature control mode, the temperature of the zone at the zone cooling temperature set point by modulating the airflow to the zone.

4. The method of claim 3, further comprising monitoring the airflow while in the second temperature control mode, and switching to the first temperature control mode if the monitored airflow is below the maximum airflow for a predetermined period of time.

5. The method of claim 1, further comprising maintaining, while in the third temperature control mode, the zone temperature at the zone heating temperature set point by heating the airflow to the zone with a heating mechanism.

6. The method of claim 5, further comprising monitoring the heating mechanism and switching to an alternative mode based at least partially on the operation of the heating mechanism.

7. The method of claim 6, further comprising monitoring operation of the heating mechanism and the temperature of the zone, and switching to the first temperature control mode when the heating mechanism is not heating the airflow and the temperature of the zone reaches the zone cooling temperature set point.

8. The method of claim 5, further comprising initiating an alarm based if the zone temperature does not increase over a period of time while in the third temperature control mode.

9. A temperature control system for a zone, the temperature control system comprising:
an airflow source configured to provide airflow to the zone;
an airflow measurement device configured to measure airflow to the zone;
a damper configured to control airflow to the zone;
a heating device configured to heat the airflow;
a thermostat device configured to measure the temperature of the zone; and
a controller configured to be in communication with the airflow measurement device, the damper, the heating device, and the thermostat, and to alter the airflow to the zone using at least one of the damper and the heating device based at least partially on the temperature of the zone and the airflow to the zone.

10. The temperature control system of claim 9, wherein the heating device is at least one hot water heated element.

11. The temperature control system of claim 9, wherein the thermostat is configured to provide a heating temperature set point and a cooling temperature set point to the controller.

12. The temperature control system of claim 11, wherein the controller alters the airflow to the zone by heating the airflow with the heating device when the temperature of the zone is below the heating temperature set point and the airflow is below a predetermined value.

13. The temperature control system of claim 9, wherein the controller alters the airflow to the zone by restricting the airflow with the damper.

14. The temperature control system of claim 9, wherein the airflow measurement device measures a pressure of the airflow.

15. A method of reconfiguring an existing temperature control system, the temperature control system having a controller and a first set of commands for controlling airflow to a zone, the method comprising:
accessing the controller;
deactivating at least a portion of the first set of commands; and
programming the controller with a second set of temperature control system commands, wherein the second set of temperature control system commands are configured to alter the airflow to the zone based on the temperature of the zone and the airflow being routed to the zone.

16. The method of claim 15, wherein the second set of temperature control system commands define a first temperature control mode, a second temperature control mode, and a third temperature control mode.

17. The method of claim 16, wherein, upon programming with the second set of temperature control system commands, the controller controls cooling of the zone using the first temperature control mode and the second temperature control mode and controls heating of the zone using the third temperature control mode.

18. The method of claim 15, wherein, upon programming with the second set of temperature control system commands, the controller alters the airflow to the zone by heating the airflow.

19. The method of claim 15, wherein, upon programming with the second set of temperature control system commands, the controller alters the airflow to the zone by restricting the airflow.

20. The method of claim 15, wherein, upon programming with the second set of temperature control system commands, the controller alters the airflow to the zone to maintain the temperature of the zone between a cooling temperature set point and a heating temperature set point included in the second set of temperature control system commands.
